(19) United States
(12) Patent Application Publication
(10) Pub. No.: US 2020/0019183 A1
(43) Pub. Date: Jan. 16, 2020

(54) SERVER AND METHOD FOR SETTING INTIAL POSITION OF ROBOT, AND ROBOT OPERATING BASED ON THE METHOD

(71) Applicant: LG ELECTRONICS INC., Seoul (KR)

(72) Inventor: Jongcheol SHIN, Seoul (KR)

(73) Assignee: LG Electronics Inc.

(21) Appl. No.: 16/557,121

(22) Filed: Aug. 30, 2019

(30) Foreign Application Priority Data
Jul. 16, 2019 (KR) 10-2019-0085957

(51) Int. Cl. G05D 1/02; B25J 9/16

(52) U.S. Cl. CPC G05D 1/0251; B25J 9/1697; B25J 9/1666; G05D 2201/0216; G05D 1/0219; G05D 1/0238; B25J 9/1661

(57) ABSTRACT

Provided are a server and method for setting an initial position of a robot, and a robot operating based on the method. In the server, the robot, and the method, past-date images or current sensing information of a place with a plurality of spaces are analyzed to estimate the number of first users who are potential customers in each of the spaces according to time intervals, and an initial position of a robot is set according to time intervals on the basis of the number of first users.

### CROSS-REFERENCE TO RELATED APPLICATION

This application claims priority to and the benefit of Korean Patent Application No. 10-2019-0085957, filed on Jul. 16, 2019, the disclosure of which is incorporated herein by reference in its entirety.

### BACKGROUND

### 1. Field of the Invention

The present invention relates to a server and method for setting an initial position of a robot according to time intervals, and a robot moving based on the method.

### 2. Discussion of Related Art

Robots are capable of moving in various ways. Robots are capable of storing a map for an entire space and creating a movement path on the map. Furthermore, robots are capable of sensing nearby obstacles with no particular map and creating a path to avoid the sensed obstacles.

When there are a plurality of movable robots in a place with a large area such as an airport, the robots may provide a specific service to users. For example, a robot may give directions or introduce goods and services provided by malls.

However, when users who desire a specific service of the robot are crowded in a space that is far away from the robot, the robot cannot effectively provide the specific service.

When the robot is located in a space in which there are a small number of users, an idle time in which the robot does not provide the service occurs and thus the robot cannot be used effectively.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings in which:

FIG. 1 is a diagram illustrating an example of a place in which a plurality of robots are located according to an embodiment of the present invention;

FIG. 2 is a schematic diagram illustrating a configuration of a management server according to an embodiment of the present invention;

FIG. 3 is a flowchart of a method of setting an initial position of a robot in a first time interval by a management server according to an embodiment of the present invention;

FIG. 4 is a diagram illustrating a concept of a region of a space according to the present invention;

FIG. 5 is a diagram illustrating an example of setting an initial position of a robot according to the present invention; and

FIG. 6 is a schematic block diagram of a configuration of a robot according to an embodiment of the present invention.

### DETAILED DESCRIPTION OF EXEMPLARY EMBODIMENTS

Hereinafter, embodiments of the present invention will be described in detail with reference to the accompanying drawings so that those of ordinary skill in the art can easily implement the embodiments. The present invention may be embodied in many different forms and is not limited to the embodiments set forth herein.

For clarity, parts not related to explaining the present invention are omitted herein, and the same reference numerals are assigned to the same or like components throughout the specification. Some embodiments of the present invention will be described below in detail with reference to exemplary drawings. In the drawings, the same reference numerals are used to denote the same elements throughout the drawings even when the elements are shown in different drawings. In the following description, well-known functions or constructions are not described in detail when it is determined that they would obscure the invention due to unnecessary detail.

In describing components of the present invention, the terms first, second, A, B, (a), (b), etc. may be used. These terms are merely used herein to distinguish each component from other components and thus the natures, sequence, order, or number of the components corresponding thereto are not limited by these terms. When an element is referred to as being “coupled to”, “combined with”, or “connected to” another element, it should be understood that the element may be directly coupled to, combined with, or connected to the other element or may be coupled to, combined with, or connected to the other component while another element is interposed therebetween or via another element.

For convenience of explanation, elements of the present invention may be divided into sub-elements and explained but the elements may be included in one device or module or one element may be divided into sub-elements and included in a plurality of devices or modules.

Hereinafter, the term “robot”, when used herein, may refer to a machine that automatically handles a given task or operates with its own capabilities. In particular, a robot having a function of identifying an environment and determining and performing an operation may be referred to as an intelligent robot. Here, the function of the robot includes various functions that may be provided by moving devices, e.g., a function such as cleaning, creating a map, or providing content, a security function, and the like.

The robot includes a driving unit having an actuator or a motor to perform various physical operations such as moving joints thereof. In addition, a wheel, a brake, a propeller, and the like are included in a driving unit of a movable robot and thus the movable robot is capable of moving on the ground or flying in the air through the driving unit.

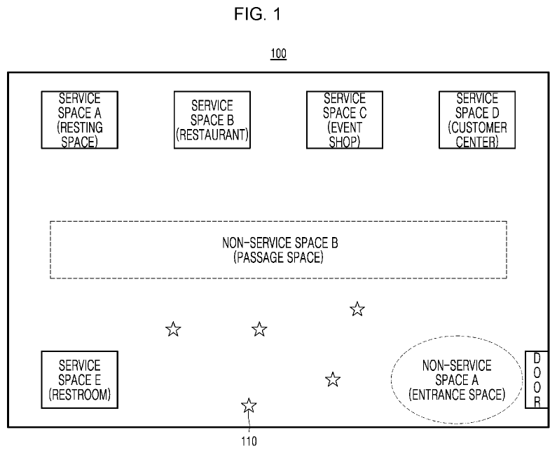

FIG. 1 is a diagram illustrating an example of a place in which a plurality of robots are located according to an embodiment of the present invention.

A place 100 may be a place with a large area such as an airport or the like and include a plurality of spaces. Each of a plurality of robots 110 is a device which is movable and provides a service to users. For example, the service provided by the plurality of robots 110 includes a route guidance service, an introduction service of goods/services provided by shopping malls, and the like.

The plurality of spaces include at least one service space in which a specific service is provided and at least one non-service space in which the specific service is not provided.

For example, the service space may be a restaurant, an event shop, a duty-free shop, a restroom, a customer center, a lounge, an airport arrivals hall, or the like, and the non-service space may be a space (entrance space) connected to an entrance of the place 100, a passage space of a place, or the like.

In this case, the at least one service space may include a first service space in which a users' intent to use the service provided in the service space is clear, and a second service space in which the users' intent to use the service is not clear.

That is, the first service space is a space in which users intentionally enter with a clear purpose. For example, the first service space may be a restaurant, a restroom, a customer center, an airport arrivals hall, or the like. The second service space is a space in which users enter without a clear purpose. For example, the second service space may be an event shop, a duty-free shop, a lounge, or the like. In this case, the first service space and the second service space may be defined in advance.

Users who can receive the services of the plurality of robots 110 may be located in the place 100, and many of the users may be located in a specific space of the place 100 according to time intervals. Therefore, according to the present invention, in order to efficiently provide services of a robot to users, the number of first users who are potential customers and can receive the services of the robot among users is estimated according to time intervals, and an initial position of the robot is set according to the time intervals based on the number of first users.

Setting an initial position of a robot in one time interval (i.e., a first time interval, for example, from 11:00 to 12:00) on a specific date according to the present invention will be described in more detail below with reference to the following drawings. In this case, the following description is equally applicable to setting an initial position of a robot in all time intervals on a specific date.

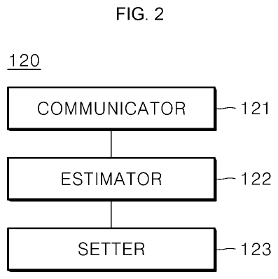

FIG. 2 is a diagram illustrating a schematic configuration of a management server 120 according to an embodiment of the present invention.

Referring to FIG. 2, the management server 120 is an apparatus for setting an initial position of at least one robot 110 located in a specific place according to time intervals and includes a communicator 121, an estimator 122, and a setter 123.

The communicator 121 communicates with a closed-circuit television (CCTV) and the at least one robot 110 which are located in a place. For example, the communicator 121 may include a mobile communication module, a short distance communication module, and the like. Meanwhile, the images can be obtained in the above-mentioned CCTV and the like.

The mobile communication module may transmit a radio signal to or receive a radio signal from at least one of a base station, an external terminal device, or a communication server in a mobile communication network established according to mobile communication technology standards or a communication method, e.g., the Global System for Mobile communication (GSM), Code Division Multi-Access (CDMA), CDMA2000, Enhanced Voice-Data Optimized or Enhanced Voice-Data Only (EV-DO), Wideband CDMA (WCDMA), High-Speed Downlink Packet Access (HSDPA), High-Speed Uplink Packet Access (HSUPA), Long-Term Evolution (LTE), LTE-Advanced (LTE-A), or the like.

The short-range communication module is for short-range communication and includes at least one of Bluetooth, Radio Frequency IDentification (RFID), Infrared Data Association (IrDA), Ultra Wideband (UWB), ZigBee, Near-Field Communication (NFC), WirelessFidelity (Wi-Fi), Wi-Fi Direct, or Wireless Universal Serial Bus (USB) technology.

The estimator 122 and the setter 123 may be processor-based modules. Here, the processor executes computer-readable instructions stored in a memory included in the management server 120. The processor may include one or more among a central processing unit (CPU), an application processor, and a communications processor.

The estimator 122 performs a function of estimating the number of first users for each space. Here, the first users refer to potential customers who can be provided with a service of the at least one robot 110 among users located adjacent to each space. The estimator 122 estimates the number of first users for each space based on images received via the communicator 121.

The setter 123 sets an initial position of the at least one robot 110 in a first time interval on a current date. In this case, the number of first users, which is estimated for each space by the estimator 122, is used.

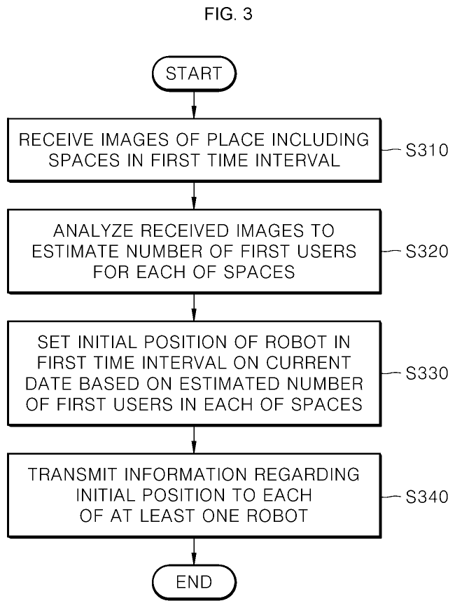

FIG. 3 is a flowchart of a method of setting an initial position of at least one robot 110 in a first time interval on a current date, the method being performed by a management server 120 according to an embodiment of the present invention. Operations of the method will be described in detail below.

First, the communicator 121 receives images of places including a plurality of spaces in a first time interval (S310). In this case, the received images are images obtained in a first time interval on a past date.

The images may be obtained by the at least one robot 110 and at least one CCTV placed in the plurality of places. Thus, the communicator 121 may receive the images from the at least one robot 110 and the at least one CCTV.

Next, the estimator 122 analyzes the received images to estimate the number of first users in each of the spaces (S320).

Here, as described above, the first users refer to potential customers who can be provided with a service of the at least one robot 110 among users located in regions of the spaces.

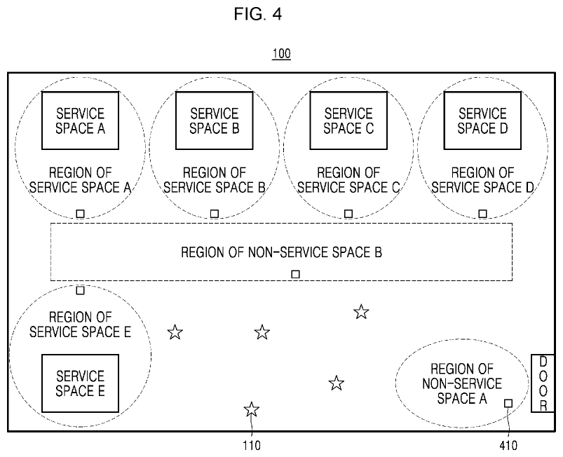

FIG. 4 is a diagram illustrating a concept of a region of a space according to the present invention. Referring to FIG. 4, a region of a space corresponds to a region spaced a predetermined distance or less from the space. A standby position 410 of a robot 110 is set in advance for each space.

The estimating of the number of first users in each of the spaces will be described in more detail below.

Next, the setter 123 sets an initial position of the at least one robot 110 in the first time interval on the current date based on the estimated number of first users in each of the spaces (S330). For example, a robot standby position is set in advance in each of the spaces and the setter 123 sets one of the robot standby positions in the spaces to the initial position of the robot 110 in the first time interval on the current date based on the estimated number of first users in each of the spaces 110.

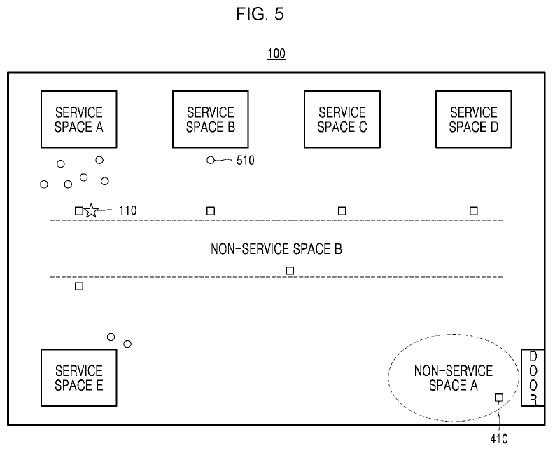

In an embodiment of the present invention, when there is one robot 110 in a place, the setter 123 may set a robot standby position in a first space in which there is the largest number of first users among the spaces to the initial position of the robot 110 in the first time interval. This is illustrated in FIG. 5, and a robot standby position in a space in which there is a largest number of first user 510 may be set to a robot's initial position.

That is, the setter 123 may set a position (the robot standby position in the first space) adjacent to the first space in which there is a largest number of potential customers to the initial position of the robot 110 in the first time interval.

In another embodiment of the present invention, when there are a plurality of robots 110 in a place, the setter 123 may individually set an initial position of each of the plurality of robots 110 in the first time interval.

More specifically, the setter 123 searches the spaces for a space in which the number of first users is equal to or greater than a first threshold value. The first threshold value is a value which is set in advance based on the number of users in images in a first time interval on a past date. The first threshold value may be less than a maximum number of first users.

When there is one space in which the number of first users is equal to or greater than the first threshold value, the setter 123 sets the initial position of each of the plurality of robots 110 in the first time interval to a robot standby position in the one space.

On the contrary, when there are two or more spaces in which the number of the first users is equal to or greater than the first threshold value, the setter 123 may set one of robot standby positions in the two or more spaces to initial positions of the plurality of robots 110. The number of the robots 110, the initial positions of which are set to one of the robot standby positions in the two or more spaces, may be proportional to the number of first users in the two or more spaces.

That is, when there are a plurality of robots 110 in a place and all of initial positions of the plurality of robots 110 are set to robot standby positions in a space in which there is the largest number of potential customers, first users located in another space cannot be provided with a service of the robot 110. Thus, the plurality of robots 110 cannot be efficiently used.

Accordingly, for efficient use of the plurality of robots 110, the setter 123 sets the initial positions of the plurality of robots 110 to one of the robot standby positions in the two or more spaces such that the number of robots 110 to be distributed is increased as the number of first users increases and is decreased as the number of first users decreases.

Finally, the communicator 121 transmits information regarding the initial position to each of the at least one robot 110 (S340). The at least one robot 110 receiving the information regarding the initial position moves to the initial position at a first time point in the first time interval.

In other words, according to the present invention, the initial position of the at least one robot 110 is set to a space of a place with a large area in which a service provided by the at least one robot 110 has been required frequently so that users may receive the service of the at least one robot 110 without waiting. In addition, according to the present invention, an idle time in which the at least one robot 110 does not provide the service may be minimized and thus the at least one robot 110 may be used effectively.

Estimating the number of first users in each of the spaces by the estimator 122 will be described in detail below.

According to one embodiment of the present invention, the estimator 122 may estimate the number of users in each of regions of spaces and information regarding the users' moving (or users' walking) by analyzing an image in a first time interval on a past date, and estimate the number of first users who want to receive a service from the robot 110 in each of the spaces on the basis of the estimated information regarding the users' moving. In this case, the information regarding the users' moving may include at least one of information as to whether or not the users are entering or leaving the spaces or information regarding users' moving pattern in the regions of the spaces.

Here, the entry into the space corresponds to the users' movement into the space, and the leaving of the space corresponds to the users' movement from the space. The users' moving pattern includes the users' moving speeds in the region of the space, the users' wandering in the space, and the like.

For example, when it is determined that a user's appearance from the front is detected and the user's walking direction is a direction away from the space, the estimator 122 estimates that the user is leaving the space. When it is determined that the user's appearance from behind is detected and the user's walking direction is a direction toward the inside of the space, the estimator 122 estimates that the user is entering the space.

Estimating by the estimator 122 whether a user is a first user (a potential customer) according to the type of a space will be described in detail below.

In an embodiment of the present invention, the estimator 122 may estimate a user who is leaving a first service space as a first user in the first service space.

As described above, the first service space is a service space that users intentionally enter with a clear purpose. That is, a user entering the first service space may have a strong desire to use a service provided in the first service space. Thus, the estimator 122 excludes the user entering the first service space from first users.

A user who is leaving the first service space is a user who has been provided with the service of the first service space and thus may be ready to receive another service (i.e., a service provided by the at least one robot 110). Thus, the estimator 122 estimates the user leaving the first service space as a first user.

In an embodiment of the present invention, the estimator 122 may estimate a user entering a second service space or a user leaving the second service space as a first user in the second service space.

As described above, the second service space is a space that users enter without a clear purpose. That is, the user entering the second service space is a user who may or may not use a service provided in the second service space. Therefore, in order to include a number of all cases, the estimator 122 may estimate both a user entering the second service space and a user leaving the second service space as first users.

In an embodiment of the present invention, the estimator 122 may estimate a user entering a first non-service space of a non-service space, which is connected to an entrance of a place, to be a first user in the first non-service space.

More specifically, a user leaving via an entrance of a place, i.e., a user leaving the first non-service space, is likely to be a user who has finished his or her plans in the place. Therefore, the estimator 122 excludes a user who is leaving the first non-service space from first users.

A user entering the place via the entrance of the place, i.e., a user entering the first non-service space, is a user who will perform his or her plans in the place. Thus, the user is likely to be provided with the service of the at least one robot 110. Accordingly, the estimator 122 may estimate a user entering the first non-service space as a first user in the first non-service space.

Estimating, by the estimator 122, whether a user is a first user (a potential customer) according to the user's walking pattern will be described in detail.

In an embodiment of the present invention, when a walking speed of the user in a region of a space is less than a predetermined critical speed, the user may be estimated as a first user in the space. In this case, the critical speed may be set experimentally. For example, the critical speed may be half an average walking speed of a human being.

More specifically, when a user does not walk in a region of a space, i.e., inside or outside the space (e.g., when the user is sitting on a chair, i.e., when a walking speed of the user=0), the user may be taking a rest, waiting for someone, or waiting for an event to be performed in a specific space and is likely to use the service provided by the at least one robot 110. Thus, the estimator 122 may estimate the user who does not walk in the region of the space as a first user in the space.

A user who is walking in a region of a space at a slow speed (i.e., a walking speed less than a critical speed) may be waiting for someone, be waiting for an event to be performed in a specific space, or be looking around specific spaces and is likely to use the service provided by the at least one robot 110. Thus, the estimator 122 may estimate the user who is walking in the region of the space at a walking speed less than the critical speed to be a first user.

In an embodiment of the present invention, when a user located in a region of a space is roaming around the space, the user may be estimated as a first user in the space. That is, because the user who is roaming around the space is likely to be waiting for someone or an event to be performed in a specific space, the estimator 122 may estimate the user as a first user in the space.

In another embodiment of the present invention, the estimator 122 may estimate a first user in a service region from a combination of information as to whether or not users are entering or leaving a space and information regarding users' moving patterns in a region of the space.

That is, when a user leaving one of at least one service space is walking at a speed less than a critical speed or is roaming around the service space, the estimator 122 may estimate the user as a first user in the service space.

For example, when a user leaving a first service space is walking at a slow speed, the estimator 122 may estimate the user as a first user in the first service space.

For example, the estimator 122 may increase the accuracy of estimation by estimating a first user by combining the two pieces of information.

In an embodiment of the present invention, the estimator 122 may estimate the number of first users for each space using an algorithm model based on an artificial neural network. For example, the algorithm model may be a human face recognition and tracking algorithm model, which is a deep-learning-based object classifier. This will be described in more detail below.

Artificial intelligence refers to artificial intelligence or the field of studying methodology therefor. Machine learning is a field of defining various issues dealt with in the field of artificial intelligence and studying methodology therefor. Machine learning may be defined as an algorithm for enhancing the performance of a task through continual experiences thereof.

An artificial neural network (ANN) is a model used in machine learning and may refer to all models consisting of artificial neurons (nodes) forming a network through combination of synapses and having problem-solving capabilities. The artificial neural network may be defined by a connection pattern between neurons at different layers, a learning process for updating model parameters, and an activation function for generating an output value.

The artificial neural network may include an input layer and an output layer and selectively include at least one hidden layer. Each of these layers includes at least one neuron, and an artificial neural network may include synapses that connect neurons to each other. In the artificial neural network, each neuron may output a function value of the activation function with respect to input signals, a weight, and deflection values, which are input via the synapse.

The model parameters refer to parameters determined through learning and include a weight for connection of synapses, a deflection value of neurons, and the like. Hyper parameters refer to parameters of a machine learning algorithm to be set before learning and include a learning rate, the number of repetitions, a mini-batch size, an initialization function, and the like.

Determining model parameters for minimizing a loss function may be considered as an objective of training the artificial neural network. The loss function may be used as an index to determine optimal model parameters in a process of training the artificial neural network.

Machine learning may be classified into supervised learning, unsupervised learning, and reinforcement learning according to a learning method.

Supervised learning may refer to a method of training an artificial neural network when a label is given in relation to training data. The label may refer to a correct answer (or a result value) to be inferred by the artificial neural network when the training data is input to the artificial neural network. Unsupervised learning may refer to a method of training an artificial neural network when a label is not given in relation to training data. Reinforcement learning may refer to a training method in which an agent defined in an environment is trained to select an action or a sequence of actions for maximizing cumulative reward in each state.

Among artificial neural networks, machine learning implemented with a deep neural network (DNN) which includes a plurality of hidden layers may be also referred to as deep learning. Deep learning is part of machine learning. The term “machine learning” should be hereinafter understood to include deep learning.

Referring to the above description, an artificial-neural-network-based algorithm model for estimation of the estimator 122 of the present invention includes an input layer having an input node, an output layer having an output node, and at least one hidden layer having a hidden node and disposed between the input layer and the output layer. In this case, the algorithm model is trained with training data, and a weight of an edge connecting nodes and biases of the nodes may be updated through training.

Information regarding users' moving which is extracted from images may be input to the input layer of the trained algorithm model, and the number of first users may be output to the output layer of the trained algorithm model.

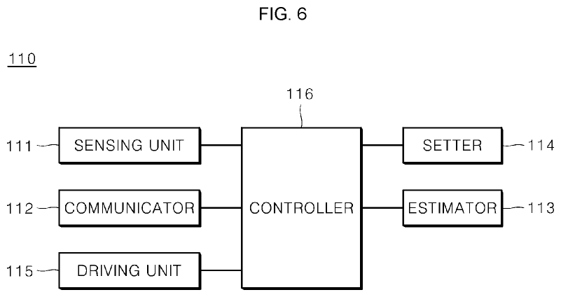

According to the present invention, the robot 110 may autonomously set an initial position thereof in a first time interval and move to the initial position. An operation of the robot 110 will be described with reference to FIG. 6 below.

FIG. 6 is a schematic block diagram of a configuration of a robot according to an embodiment of the present invention.

Referring to FIG. 6, a robot 110 includes a sensing unit 111, a communicator 112, an estimator 113, a setter 114, a driving unit 115, and a controller 116.

In this case, the estimator 113, the setter 114, and the controller 116 may be processor-based modules. Here, the processor executes computer-readable instructions stored in a memory included in the robot 110. The processor may include at least one of a CPU, an application processor, and a communications processor.

The sensing unit 111 includes a plurality of sensors, and senses information related to the number of users in a plurality of spaces at a time point earlier than a first time interval. For example, the sensing unit 111 may include at least one of an image sensor (i.e., a camera), an acceleration sensor, a gyro sensor, a Light Detection and Range (LiDAR) sensor, an infrared sensor, an ultrasonic sensor, a radio-frequency (RF) sensor, a geomagnetic sensor, or a position sensitive device (PSD) sensor.

The communicator 112 receives information regarding initial positions of other robots. This information may be received from the other robots or the management server 120.

The estimator 113 estimates the number of users in each of regions of the spaces using the sensed information, estimates information regarding the estimated users' moving, and estimates the number of first users who want to receive a service from the robot 110 in each of the spaces on the basis of the estimated information regarding the users' moving.

In this case, the estimator 113 may estimate information regarding the estimated users' moving by analyzing image information sensed by the image sensor. The information regarding the users' moving may include at least one of information as to whether or not the users are entering or leaving the spaces or information regarding the users' moving pattern in the regions of the spaces. The estimator 113 estimates the number of first users in each of the spaces on the basis of the estimated information regarding the users' moving.

The setter 114 sets an initial position of the robot 110 in the first time interval on the basis of the estimated number of first users in each of the spaces. In this case, a robot standby position is set in advance in each of the spaces, and the setter 114 sets one of the robot standby positions in the spaces to an initial position of the robot 110 in the first time interval based on the estimated number of first users for each space.

The driving unit 115 moves the robot 110. The controller 116 controls the driving unit 115 and other components of the robot 110. For example, the controller 116 controls the driving unit 115 to move the robot 110 to the initial position.

In an embodiment of the present invention, the setter 114 may set a robot standby position in a first space, which is estimated as a space in which there is a largest number of first users among spaces, to the initial position of the robot 110.

Operations of the robot 110 are substantially the same as those performed by the management server 120 and thus a detailed description thereof will be omitted herein.

In an embodiment of the present invention, the setter 114 may change the initial position when a large number of other robots are located at the initial position of the robot 110.

That is, the robot 110 may autonomously drive, and the robot 110 and a plurality of other robots may perform the same operation. Accordingly, a situation in which all robots are placed at the same initial position may occur and thus the robot 110 may be inefficiently used. To prevent the problem, the robot 110 operates as described below.

First, the robot 110 receives information regarding initial positions of a plurality of other robots through the communicator 112.

The setter 114 compares the initial positions of the plurality of other robots with that of the robot 110.

The setter 114 does not change the initial position of the robot 110 when the initial position of at least one of the plurality of other robots is the robot standby position in the first space which is equal to the initial position of the robot 110 and the number of at least one other robot is less than a second threshold value. That is, when the number of other robots having the same initial position as that of the robot 110 is not large, the initial position of the robot 110 is not changed.

In contrast, the setter 114 changes the initial position of the robot 110 when the initial position of at least one of the plurality of other robots is the robot standby position in the first space which is equal to the initial position of the robot 110 and the number of at least one other robot is greater than or equal to the second threshold value. That is, when the number of other robots having the same initial position as that of the robot 110 is large, the setter 114 changes the initial position of the robot 110.

For example, the setter 114 changes the initial position of the robot 110 to a robot waiting space in a second space in which there is a second largest number of first users.

Accordingly, the robot 110 may be used efficiently.

According to the present invention, an initial position of a robot is set to a space of a place with a large area in which a service provided by the robot has been required frequently so that users may receive the service of the robot without waiting.

In addition, according to the present invention, an idle time in which no service is provided by a robot may be minimized and thus the robot can be used effectively.

It should be understood that effects of the present invention are not limited thereto and include all effects that can be deduced from the above description of the present invention and the subject matters of the present invention defined in the appended claims.

Although it is described that all components of an embodiment of the present invention are combined with each other or are operated while being combined with each other, the present invention is not necessarily limited thereto, and at least one of all the components may be operated while being selectively combined with each other without departing from the scope of the present invention. Although each of all the components may be embodied as independent hardware, some or all of the components may be selectively combined to realize a computer program having a program module which performs some or all of functions of a combination of one or more hardware units. Code and code segments constituting the computer program can be easily reasoned by those of ordinary skill in the art. The computer program may be stored in a computer-readable medium, and an embodiment of the present invention may be implemented by reading and executing the computer program. Examples of the computer-readable medium storing the computer program include a magnetic recording medium, an optical recording medium, and a storage medium with a semiconductor recording element. The computer program for implementing the present invention includes a program module transmitted in real time via an external device.

The present invention is directed to providing a server and a method for analyzing a space of a place with a large area in which a service of a robot is required frequently and setting an initial position of the robot on the basis of the result of analysis, and a robot operating based on the method.

Aspects of the present invention are not limited thereto, and other aspects and advantages of the present invention which are not mentioned herein will be apparent from the following description and will be more clearly understood by embodiments of the present invention. It will also be readily understood that aspects and advantages of the invention can be implemented by means defined in the appended claims and a combination thereof.

To address the above problems, in a server, a robot and a method according to embodiments of the present invention, past-date images or current sensing information of a place with a plurality of spaces are analyzed to estimate the number of first users who are potential customers in each of the spaces according to time intervals, and an initial position of a robot is set according to the time intervals on the basis of the number of first users.

According to an aspect of the present invention, a robot management server includes a memory storing computer-readable instructions, and a processor configured to execute the instructions, wherein the processor estimates the number of users located in each of regions of spaces included in a place and information regarding the users' walking by analyzing the image of the place in the first time interval of the past date, estimates the number of first users who want to receive a service from a robot in each of the spaces on the basis of the estimated information regarding the users' walking, and sets an initial position of the robot in a first time interval on a current date on the basis of the estimated number of first users in each of the spaces, wherein the information regarding the users' walking includes at least one of information as to whether or not the users enter or leave the spaces and information regarding the users' walking pattern in regions of the spaces.

According to another aspect of the present invention, a robot includes a sensing unit configured to sense information related to the number of users located in a plurality of spaces at a time point earlier than a first time interval, a memory storing computer-readable instructions, and a processor configured to execute the instructions, wherein the processor estimates the number of users located in each of regions of the spaces and information regarding the users' walking using the sensed information, estimates the number of first users who want to receive a service from a robot in each of the spaces on the basis of the estimated information regarding the users' walking, and sets an initial position of the robot in the first time interval on the basis of the estimated number of first users in each of the spaces, wherein the information regarding the users' walking includes at least one of information as to whether or not the users enter or leave the spaces and information regarding the users' walking pattern in regions of the spaces.

According to another aspect of the present invention, a method of setting an initial position of a robot includes estimating the number of users located in each of regions of spaces included in a place and information regarding the users' walking by analyzing the image of the place in the first time interval of the past date, estimating the number of first users who want to receive a service from a robot in each of the spaces on the basis of the estimated information regarding the users' walking, and setting an initial position of the robot in a first time interval on a current date on the basis of the estimated number of first users in each of the spaces, wherein the information regarding the users' walking includes at least one of information as to whether or not the users enter and leave the spaces or information regarding the users' walking pattern in regions of the spaces.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A robot management server comprising:
a memory to store instructions; and
a processor configured to execute the instructions to perform operations for;
estimating the number of users located in each corresponding region of a plurality of spaces included in a place and information regarding the users' moving, by analyzing at least one image of the place in a first time interval on a past date,
estimating, for each of the spaces, the number of first users believed to want to receive a service from a robot, based on the estimated information regarding the users' moving, and
setting an initial position of the robot in a first time interval on a current date, based on the estimated number of first users for each of the spaces,
wherein the information regarding the users' moving includes at least one of information regarding whether or not the users enter or leave the spaces and information regarding the users' moving pattern in the regions of the spaces.

2. The robot management server of claim 1, further comprising a communication unit configured to receive, from an external device, the at least one image in the first time interval on the past date, and to transmit, to the robot, information regarding the set initial position of the robot.

3. The robot management server of claim 1, wherein a plurality of robot standby positions are set in advance for each separate one of the spaces, and
the processor sets one of the robot standby positions as the initial position of the robot.

4. The robot management server of claim 3, wherein the processor selects a first space in which the estimated number of first users is largest from among the plurality of spaces, and sets the robot standby position of the first space as the initial position of the robot.

5. The robot management server of claim 3, wherein, when there are a plurality of robots in the place and two or more of the spaces have the estimated number of first users being greater than or equal to a first threshold value, the processor sets one of the robot standby positions of the two or more spaces as an initial position of each of the plurality of robots in the place,
wherein a number of the robots, the initial position of which is set to one of the robot standby positions in the two or more of the spaces, is proportional to the number of first users in each of the two or more of the spaces.

6. The robot management server of claim 1, wherein the plurality of spaces comprise at least one service space in which the service is provided,
wherein the at least one service space includes at least one of:
a first service space defined a space in which a users' intent to use the service provided therein is clear; and
a second service space in which the users' intent to use the service provided therein is not clear.

7. The robot management server of claim 6, wherein the processor estimates a user leaving the first service space as a first user of the first service space, and estimates a user entering or leaving the second service space as a first user of the second service space.

8. The robot management server of claim 7, wherein, when a moving speed of a user leaving one of the at least one service space is less than a critical speed or the user roams around the one service space, the processor estimates the user as a first user of the one service space.

9. The robot management server of claim 1, wherein the plurality of spaces include at least one non-service space in which the service is not provided,
wherein the at least one non-service space includes a first non-service space connected to an entrance of the place, and
the processor estimates a user entering the entrance of the first non-service space as a first user of the first non-service space.

10. The robot management server of claim 1, wherein, when a moving speed of a user in a region of one of the spaces is less than a predetermined critical speed or the user roams around one of the spaces, the processor estimates the user as a first user of the one of the spaces.

11. The robot management server of claim 1, wherein the processor estimates the number of first users in each of the spaces based on an algorithm model of an artificial neural network,
wherein the algorithm model comprises:
an input layer that includes an input node;
an output layer that includes an output node; and
at least one hidden layer disposed between the input layer and the output layer, and that includes a hidden node,
wherein a weight of an edge connecting the nodes and biases of the nodes are updated by training the algorithm model.

12. The robot management server of claim 11, wherein the information regarding users' moving is input to the input layer of the trained algorithm model, and the number of first users is output from the output layer of the trained algorithm model, wherein the information of the moving is extracted from the at least one image.

13. A robot comprising:
a sensing unit configured to sense information related to a number of users located in a plurality of spaces at a time point earlier than a first time interval;
a memory configured to store instructions; and
a processor configured to execute the instructions to perform operations for:
estimating the number of users located in each corresponding region of the plurality of spaces and information regarding the users' moving, based on the sensed information relating to the number of users,
estimating, for each of the spaces, the number of first users believed to want to receive a service from a robot, based on the estimated information regarding the users' moving, and
setting an initial position of the robot in the first time interval, based on the estimated number of first users for each of the spaces,
wherein the information regarding the users' moving includes at least one of information regarding whether or not the users enter or leave the spaces and information regarding the users' moving pattern in the regions of the spaces.

14. The robot of claim 13, wherein the sensing unit includes an image sensor, and
the processor estimates the information regarding the users' moving by analyzing image information obtained by the image sensor.

15. The robot of claim 13, wherein a plurality of robot standby positions are set in advance for each separate one of the spaces, and
the processor sets one of the robot standby positions as the initial position of the robot.

16. The robot of claim 15, wherein the processor selects a first space in which the estimated number of first users is largest from among the plurality of spaces, and sets the robot standby position in the first space as the initial position of the robot.

17. The robot of claim 16, further comprising a communication unit configured to receive information regarding initial positions of a plurality of other robots,
wherein, when it is determined that the initial position of at least one of the plurality of other robots is identical to the robot standby position of the first space and the number of the at least another robot is greater than or equal to a second threshold value, the processor changes the initial position of the robot to an initial position in a space other than the first space.

18. A method of setting an initial position of a robot, performed by a processor, the method comprising:
estimating the number of users located in each corresponding region of a plurality of spaces included in a place and information regarding the users' moving, by analyzing at least one image of the place in a first time interval on a past date,
estimating, for each of the spaces, the number of first users believed to want to receive a service from a robot, based on the estimated information regarding the users' moving, and
setting an initial position of the robot in a first time interval on a current date, based on the estimated number of first users in each of the spaces,
wherein the information regarding the users' moving includes at least one of information regarding whether or not the users enter or leave the spaces and information regarding the users' moving pattern in the regions of the spaces.

19. The method of claim 18, comprising receiving, at the robot, information regarding the set initial position.

20. The method of claim 18, wherein setting the initial position includes selecting a first space in which the estimated number of first users is largest from among the plurality of spaces, and setting a robot standby position of the first space as the initial position of the robot.
